(19) United States
(12) Patent Application Publication
(10) Pub. No.: US 2005/0208331 A1
(43) Pub. Date: Sep. 22, 2005

(54) Organic electroluminescent device and electronic appliance

(75) Inventor: Tsuyoshi Maeda, Kai-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/037,302

(22) Filed: Jan. 19, 2005

(30) Foreign Application Priority Data
Mar. 16, 2004 (JP) 2004-074303

(51) Int. Cl. H05B 33/12

(52) U.S. Cl. 428/690; 428/917; 313/504; 313/506; 313/112; 257/98

(57) ABSTRACT

To provide an organic electroluminescent device that includes an organic functional layer having high luminous efficiency to provide a bright display. An organic electroluminescent device includes a substrate and an organic electroluminescent element provided on the substrate. The organic electroluminescent element includes a first electrode, a second electrode, and an organic functional layer disposed therebetween. The organic functional layer contains a side-chain liquid crystalline polymer having side chain parts facing the first electrode or second electrode.

### BACKGROUND

The present invention relates to organic electroluminescent (EL) devices and electronic appliances.

Organic EL devices are expected to form the next generation of displays. Organic EL devices include a substrate and an organic EL element on the substrate. The organic EL element includes upper and lower electrodes and a luminescent layer disposed between the electrodes. In a typical structure, an anode, organic functional layers (a hole-transport layer, a luminescent layer, and an electron-transport layer), and a cathode are laminated in the stated order on a transparent substrate made of, for example, glass.

In addition, various modifications have been proposed to improve the brightness and visibility of organic EL devices. An example of such proposals is the use of a liquid crystal material for the organic EL element (for example, see Patent Documents 1 to 3).

[Patent Document 1] Japanese Unexamined Patent Application Publication No. 10-321371.

[Patent Document 2] Japanese Unexamined Patent Application Publication No. 11-87064.

[Patent Document 3] Japanese Unexamined Patent Application Publication No. 2000-347432.

According to the techniques disclosed in the above patent documents, a bright display can be achieved by enhancing the luminous efficiency of organic functional layers. The present inventor, however, has confirmed that these techniques cannot provide a sufficiently bright display.

Accordingly, an object of the present invention is to solve the problem in the related art and provide an organic EL device that includes an organic functional layer having high luminous efficiency to provide a bright display, and an electronic appliance including the organic EL device.

### SUMMARY

To achieve the above object, the present invention provides an organic electroluminescent device including a substrate and an organic electroluminescent element provided on the substrate. The organic electroluminescent element includes a first electrode, a second electrode, and an organic functional layer disposed therebetween. The organic functional layer contains a side-chain liquid crystalline polymer having side chain parts facing the first or second electrode.

The brightness of an organic electroluminescent device depends on the current passing between its electrodes; therefore, the conductivity between the electrodes must be improved to provide a bright display.

Among liquid crystal materials, the present inventor has focused on side-chain liquid crystalline polymers, which have high conductivity in the longitudinal direction of the side chain parts of the polymers. The present inventor has confirmed that the above problem can be solved by using a side-chain liquid crystalline polymer for the organic functional layer in the organic electroluminescent element and allowing the side chain parts of the polymer to face the first or second electrode.

Thus the organic electroluminescent device of the present invention can provide higher conductivity between the first and second electrodes. This organic electroluminescent device can therefore emit brighter light when a predetermined voltage is applied between the first and second electrodes.

The present inventor has also confirmed that this organic electroluminescent device can provide about five times as high luminous efficiency as organic electroluminescent devices in which a main-chain liquid crystalline polymer is randomly aligned in a plane.

In the organic electroluminescent device of the present invention, the side chain parts are preferably substantially perpendicular to the first or second electrode.

If the side chain parts are substantially perpendicular to the first or second electrode, the organic electroluminescent device can provide higher conductivity in the perpendicular direction. This organic electroluminescent device can therefore emit brighter light when a predetermined voltage is applied between the first and second electrodes.

In the organic electroluminescent device of the present invention, the layer in contact with the organic functional layer may be subjected to vertical alignment treatment.

The vertical alignment treatment herein refers to a treatment for alignment in a direction in which the first and second electrodes are opposed to each other.

If the layer in contact with the organic functional layer is subjected to the alignment treatment, the side chain parts of the side-chain liquid crystalline polymer are aligned in the direction in which the first and second electrodes are opposed to each other. As a result, the organic electroluminescent device can provide higher conductivity in this direction. This organic electroluminescent device can therefore emit brighter light when a predetermined voltage is applied between the first and second electrodes.

In the organic electroluminescent device of the present invention, the organic functional layer may be a luminescent layer, a hole-transport layer, or an electron-transport layer.

In the present invention, the hole-transport layer also functions as a hole-injection layer, and the electron-transport layer also functions as an electron-injection layer.

In the organic electroluminescent device, the luminescent layer, the hole-transport layer, or the electron-transport layer has higher conductivity. This organic electroluminescent device can therefore emit brighter light when a predetermined voltage is applied between the first and second electrodes.

The organic electroluminescent device of the present invention may further include a polarizing layer disposed on the light-emitting side of the substrate; and a ¼ wavelength layer disposed between the polarizing layer and the substrate.

External light entering the organic electroluminescent device through the polarizing layer reflects off the organic electroluminescent element to enter the polarizing layer again through the ¼ wavelength layer. The ¼ wavelength layer then produces a phase shift to convert the external light component into linearly polarized light having a deviation of 90° from the external light entering the device. This linearly polarized light is absorbed into the polarizing layer and therefore does not leak out of the organic electroluminescent device.

Thus this organic electroluminescent device not only have the above advantages, but also can effectively prevent deterioration in contrast due to the reflection of external light to provide a high-quality display.

The present invention further provides an electronic appliance including the above organic electroluminescent device.

Examples of the electronic appliance include information processors, such as cellular phones, mobile information terminals, clocks, word processors, and personal computers, and large-screen televisions and monitors.

This electronic appliance can provide a high-quality display with brightness and high contrast.

### BRIEF DESCRIPTION OF THE DRAWINGS

FIG. 1 is a sectional view of an organic EL device according to a first embodiment of the present invention;

FIG. 2 is a schematic illustration of a side-chain liquid crystalline polymer used in the organic EL device in FIG. 1;

FIG. 3 is a sectional view of an organic EL device according to a second embodiment of the present invention;

FIG. 4 is a sectional view of an organic EL device according to a third embodiment of the present invention; and

FIG. 5 is a perspective view of an example of an electronic appliance according to the present invention.

### DETAILED DESCRIPTION OF EMBODIMENTS

Embodiments of the present invention will now be described with reference to the drawings, in which the size and so on of each component are suitably changed for better visibility.

### First Embodiment

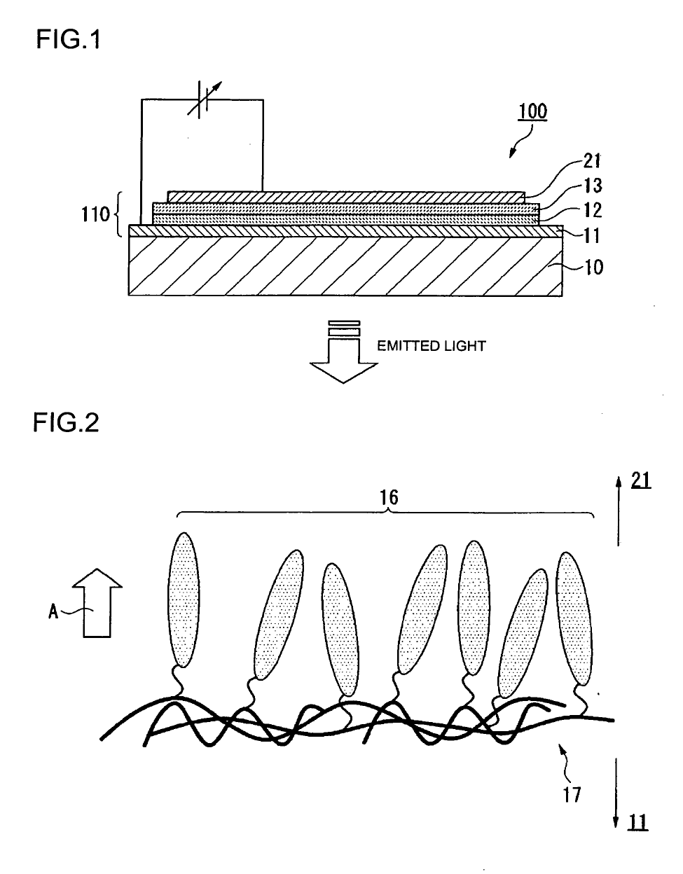

FIG. 1 is a sectional view of an organic electroluminescent (EL) device according to this embodiment. FIG. 2 is a schematic illustration of a side-chain liquid crystalline polymer used in the organic EL device. In FIG. 1, an organic EL device 100 of this embodiment has a bottom-emission structure, in which emitted light exits through a substrate.

In FIG. 1, this organic EL device 100 includes a substrate 10 and an organic EL element 110 on the substrate 10. The organic EL element 110 has a structure in which an anode (first electrode) 11 made of a transparent conductive film such as indium tin oxide (ITO), a hole-transport layer 12, a luminescent layer 13, and a cathode (second electrode) 21 made of a reflective metal film such as aluminum (Al) are laminated on the substrate 10 in the stated order. In this embodiment, the luminescent layer 13 is an organic functional layer according to the present invention. This luminescent layer 13 contains a side-chain liquid crystalline polymer.

Examples of the side-chain liquid crystalline polymer include liquid crystal compositions represented by chemical formulas 1 to 5 below and their derivatives, polymers, and mixtures. Such a liquid crystal composition may be provided on the hole-transport layer 12 to form the luminescent layer 13 containing the side-chain liquid crystalline polymer.

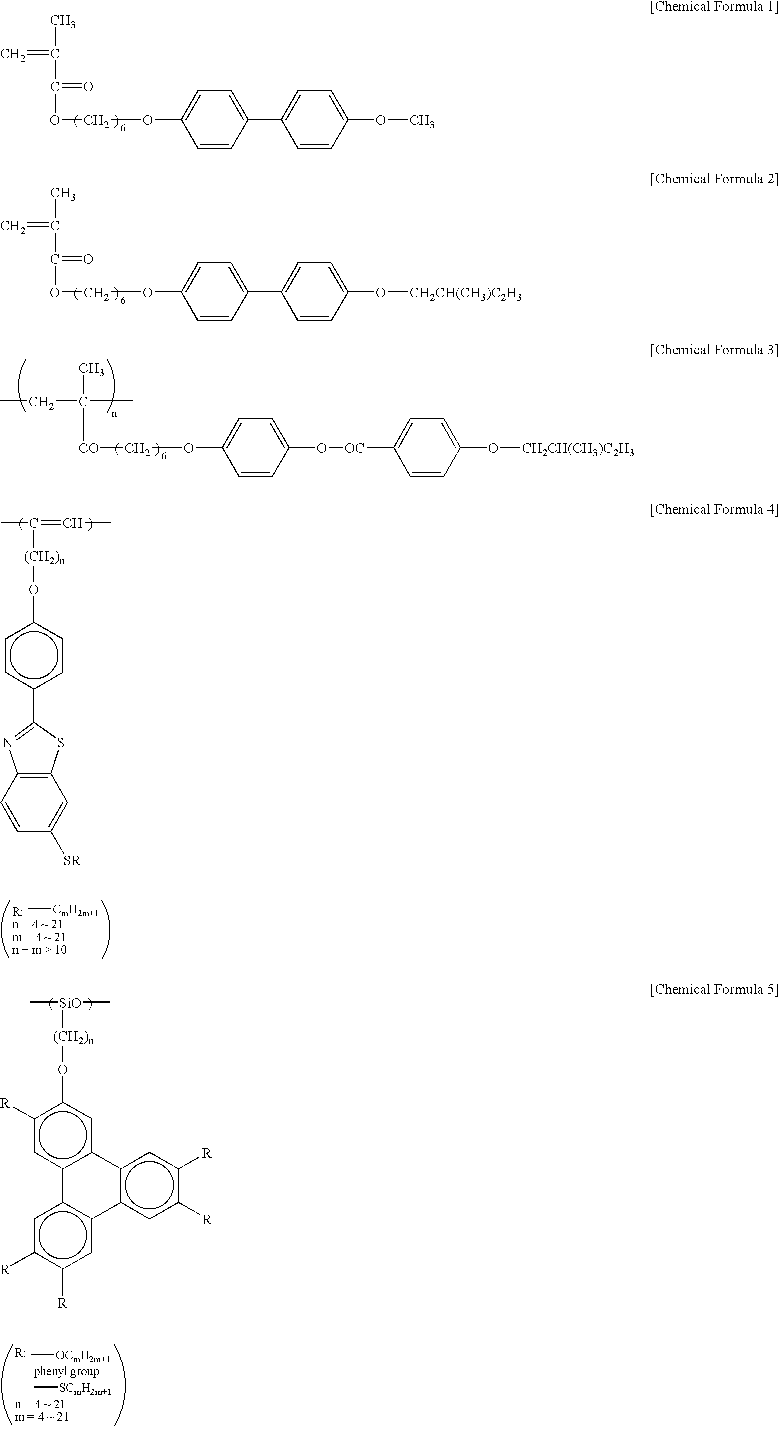

When the side-chain liquid crystalline polymer is provided on the hole-transport layer 12, main chain parts 17 and side chain parts 16 are formed, as shown in FIG. 2. The main chain parts 17 are parallel to the anode 111. The side chain parts 16 are aligned in the direction indicated by reference numeral A, namely in the direction from the anode 11 to the cathode 21, and are substantially perpendicular to the anode 11.

Not all of the side chain parts 16 are perpendicular to the anode 11; some are randomly aligned. For example, some side chain parts 16 may be inclined with respect to the perpendicular direction at a certain angle, and others may be entwined around the main chain parts 17. In this embodiment, therefore, “the side chain parts 16 are substantially perpendicular to the anode 11” means that a high proportion of the side chain parts 16 are perpendicular to the anode 11.

In FIG. 2, the main chain parts 17 are positioned on the anode 11 side while the side chain parts 16 are positioned on the cathode 21 side. In practice, the side chain parts 16, which are rotatable around the main chain parts 17 by 360°, may be positioned below the main chain parts 17, that is, may face the hole-transport layer 12. In FIG. 2, additionally, the main chain parts 17 are parallel to the anode 11; in practice, the main chain parts 17 may be inclined at a certain angle above the hole-transport layer 12.

In any case, as described above, the side chain parts 16 face the anode 11 or cathode 21, namely either electrode surface of the anode 11 or cathode 21.

Among liquid crystalline polymers for the luminescent layer 13, those having a side chain represented by chemical formula 6 below are preferred for their excellent luminous characteristics.

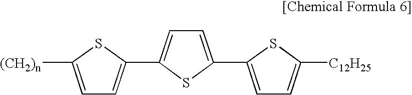

The surface of the hole-transport layer 12 in contact with the luminescent layer 13 may be subjected to vertical alignment treatment to provide the side-chain liquid crystalline polymer on a vertical alignment surface. This vertical alignment surface allows the side chain parts 16 to be aligned toward the cathode 21.

The side-chain liquid crystalline polymer can be formed by wet deposition such as spin coating and inkjetting.

A known fluorescent or phosphorescent polymer may be added to the luminescent layer 13. Examples of the luminescent polymer used include polyfluorenes (PFs), poly(p-phenylene vinylene)s (PPVs), polyphenylenes (PPs), poly(p-phenylene)s (PPPs), polyvinylcarbazole (PVK), polythiophenes, poly(dialkylfluorene) (PDAF), poly(fluorene-benzothiadiazole) (PFBT), poly(alkylthiophene) (PAT), and polysilanes such as poly(methylphenylsilane) (PMPS). The luminescent polymer may be used in combination with another material such as a perylene dye, a coumarin dye, and a rhodamine dye; or a low-molecular-weight material such as rubrene, perylene, 9,10-diphenylanthracene, tetraphenylbutadiene, Nile red, coumarin 6, and quinacridone.

The hole-transport layer 12 enhances the injection efficiency of holes from the anode 11 into the luminescent layer 13 and blocks electrons traveling through the luminescent layer 13, thus increasing the possibility of recombination between electrons and holes in the luminescent layer 13. The material for the hole-transport layer 12 preferably has a low injection barrier for holes from the anode 11 to provide high hole mobility. Examples of such a material include polythiophenes and polypyrroles, which may be doped. A specific example of the material used is a dispersion of poly(3,4-ethylenedioxythiophene)/poly(styrene sulfonate) (PEDOT/PSS). This dispersion is prepared by dispersing poly(3,4-ethylenedioxythiophene) in poly(styrene sulfonate), as a dispersion medium, and further dispersing it in water.

The anode 11 may be made of a known transparent conductive material, typically ITO.

The cathode 21 may be made of a metal such as aluminum (Al), gold (Au), silver (Ag), chromium (Cr), copper (Cu), nickel (Ni), calcium (Ca), magnesium (Mg), strontium (Sr), ytterbium (Yb), erbium (Er), terbium (Tb), and samarium (Sm), or a laminate of thin films of such metals. In this embodiment, an Al film, which has good reflectivity, is preferably used as the cathode 21. The Al film can also function to reflect light emitted by the luminescent layer 13 to the substrate 10.

The above organic EL device 100 of this embodiment emits light from the bottom surface of the substrate 10 in response to current generated when a predetermined voltage is applied between the anode 11 and the cathode 21.

According to this embodiment, as described above, the luminescent layer 13 is an organic functional layer containing a side-chain liquid crystalline polymer. The main chain parts 17 of the side-chain liquid crystalline polymer are parallel to the anode 11, and the side chain parts 16 face the cathode 21. This luminescent layer 13 can provide higher conductivity between the anode 11 and the cathode 21 to achieve higher luminous efficiency. The organic EL device 100 can therefore emit brighter light when a predetermined voltage is applied between the anode 11 and the cathode 21.

The organic EL device 100, having better luminous characteristics, can provide about five times as high luminous efficiency as organic EL devices in which a main-chain liquid crystalline polymer is randomly aligned in a plane.

In addition, the side chain parts 16 are substantially perpendicular to the anode 11 between the anode 11 and the cathode 21, thus providing higher conductivity in the perpendicular direction. The organic EL device 100 can therefore emit brighter light when a predetermined voltage is applied between the anode 11 and the cathode 21.

Furthermore, the surface of the hole-transport layer 12 in contact with the luminescent layer 13 is subjected to vertical alignment treatment to form a vertical alignment surface. This vertical alignment surface allows the side chain parts 16 to be aligned in the direction from the anode 11 to the cathode 21 above the hole-transport layer 12, thus providing higher conductivity between the anode 11 and the cathode 21. The organic EL device 100 can therefore emit brighter light when a predetermined voltage is applied between the anode 11 and the cathode 21.

### Second Embodiment

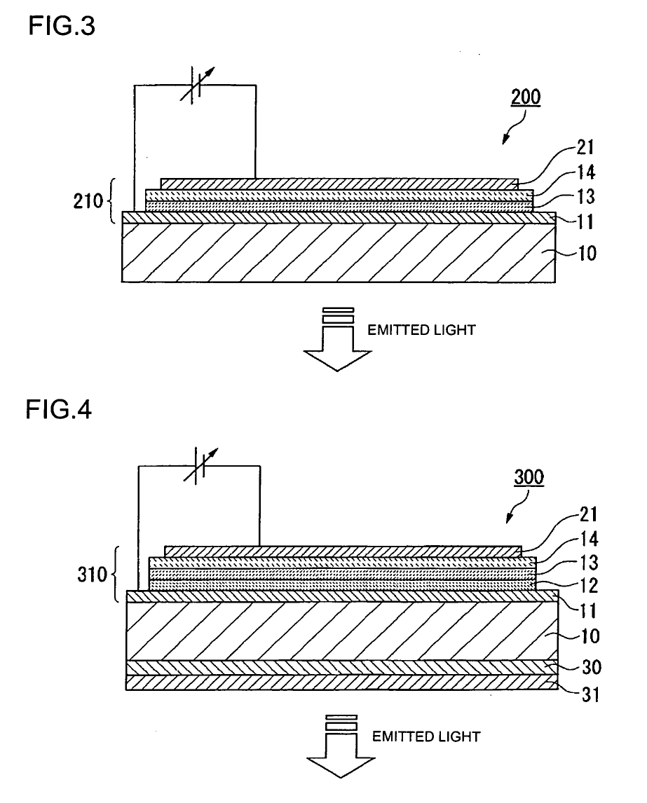

A second embodiment of the present invention will now be described in detail with reference to the drawings. FIG. 3 is a sectional view of an organic EL device according to this embodiment. In FIG. 3, the same reference numerals as in FIGS. 1 and 2 indicate the same components as in FIGS. 1 and 2 for the sake of brevity.

In FIG. 3, an organic EL device 200 includes the substrate 10 and an organic EL element 210 on the substrate 10. The organic EL element 210 has a structure in which the anode 11, which is made of a transparent conductive film such as ITO, the luminescent layer 13, an electron-transport layer 14, and the cathode 21, which is made of a reflective metal film such as Al, are laminated on the substrate 10 in the stated order. In this embodiment, the electron-transport layer 14 is an organic functional layer according to the present invention. This electron-transport layer 14 contains a side-chain liquid crystalline polymer.

Examples of the side-chain liquid crystalline polymer include the liquid crystal compositions represented by chemical formulas 1 to 5 in the first embodiment and their derivatives, polymers, and mixtures. Such a liquid crystal composition may be provided on the luminescent layer 13 to form the electron-transport layer 14 containing the side-chain liquid crystalline polymer.

When the electron-transport layer 14 is provided on the luminescent layer 13, the main chain parts 17 and the side chain parts 16 are formed, as shown in FIG. 2. The main chain parts 17 are parallel to the anode 11 above the luminescent layer 13. The side chain parts 16 are aligned in the direction indicated by reference numeral A, namely in the direction from the anode 11 to the cathode 21, and are substantially perpendicular to the anode 11 above the luminescent layer 13.

In FIG. 2, the main chain parts 17 are positioned on the anode 11 side while the side chain parts 16 are positioned on the cathode 21 side. In practice, the side chain parts 16, which are rotatable around the main chain parts 17 by 360°, may be positioned below the main chain parts 17, that is, may face the luminescent layer 13. In FIG. 2, additionally, the main chain parts 17 are parallel to the anode 11; in practice, the main chain parts 17 may be inclined at a certain angle above the luminescent layer 13.

In any case, as described above, the side chain parts 16 face the anode 11 or cathode 21, namely either electrode surface of the anode 11 or cathode 21.

Among liquid crystalline polymers for the electron-transport layer 14, those having a side chain represented by the following chemical formula 7 are preferred for their excellent electron-transport properties.

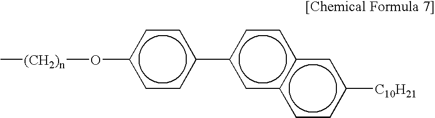

The surface of the luminescent layer 13 in contact with the electron-transport layer 14 may be subjected to vertical alignment treatment to provide the side-chain liquid crystalline polymer on a vertical alignment surface. This vertical alignment surface allows the side chain parts 16 to be aligned toward the cathode 21.

According to this embodiment, as described above, the electron-transport layer 14 is an organic functional layer containing a side-chain liquid crystalline polymer. The main chain parts 17 of the side-chain liquid crystalline polymer are parallel to the anode 11, and the side chain parts 16 face the cathode 21. This electron-transport layer 14 can provide higher conductivity between the anode 11 and the cathode 21 to achieve higher electron-injection/transport properties. The organic EL device 200 can therefore emit brighter light when a predetermined voltage is applied between the anode 11 and the cathode 21.

This organic EL device 200, having better luminous characteristics, can provide about five times as high luminous efficiency as organic EL devices in which a main-chain liquid crystalline polymer is randomly aligned in a plane.

In addition, the side chain parts 16 are substantially perpendicular to the anode 11 between the anode 11 and the cathode 21, thus providing higher conductivity in the perpendicular direction. The organic EL device 200 can therefore emit brighter light when a predetermined voltage is applied between the anode 11 and the cathode 21.

Furthermore, the surface of the luminescent layer 13 in contact with the electron-transport layer 14 is subjected to vertical alignment treatment to form a vertical alignment surface. This vertical alignment surface allows the side chain parts 16 to be aligned in the direction from the anode 11 to the cathode 21 above the luminescent layer 13, thus providing higher conductivity between the anode 11 and the cathode 21. The organic EL device 200 can therefore emit brighter light when a predetermined voltage is applied between the anode 11 and the cathode 21.

### Third Embodiment

A third embodiment of the present invention will now be described in detail with reference to the drawings. FIG. 4 is a sectional view of an organic EL device according to this embodiment. In FIG. 4, the same reference numerals as in FIGS. 1 to 3 indicate the same components as in FIGS. 1 to 3 for the sake of brevity.

In FIG. 4, an organic EL device 300 includes the substrate 10 and an organic EL element 310 on the substrate 10. The organic EL element 310 has a structure in which the anode 11, which is made of a transparent conductive film such as ITO, the hole-transport layer 12, the luminescent layer 13, the electron-transport layer 14, and the cathode 21, which is made of a reflective metal film such as Al, are laminated on the substrate 10 in the stated order. In this embodiment, the hole-transport layer 12 is an organic functional layer according to the present invention. This hole-transport layer 12 contains a side-chain liquid crystalline polymer.

In addition, a ¼ wavelength filter (¼ wavelength layer) 30 and a polarizing layer 31 are formed on the side of the substrate 10 facing away from the luminescent layer 13.

Examples of the side-chain liquid crystalline polymer include the liquid crystal compositions represented by chemical formulas 1 to 5 in the first embodiment and their derivatives, polymers, and mixtures. Such a liquid crystal composition may be provided on the anode 11 to form the hole-transport layer 12 containing the side-chain liquid crystalline polymer.

When the hole-transport layer 12 is provided on the anode 11, the main chain parts 17 and the side chain parts 16 are formed, as shown in FIG. 2. The main chain parts 17 are parallel to the anode 11 above the anode 11. The side chain parts 16 are aligned in the direction indicated by reference numeral A, namely in the direction from the anode 11 to the cathode 21, and are substantially perpendicular to the anode 11 above the anode 11.

In FIG. 2, the main chain parts 17 are positioned on the anode 11 side while the side chain parts 16 are positioned on the cathode 21 side. In practice, the side chain parts 16, which are rotatable around the main chain parts 17 by 360°, may be positioned below the main chain parts 17, that is, may face the anode 11. In FIG. 2, additionally, the main chain parts 17 are parallel to the anode 11; in practice, the main chain parts 17 may be inclined at a certain angle above the anode 11.

In any case, as described above, the side chain parts 16 face the anode 11 or cathode 21, namely either electrode surface of the anode 11 or cathode 21.

Among liquid crystalline polymers for the hole-transport layer 12, those having a side chain represented by the following chemical formula 8 are preferred for their excellent hole-transport properties.

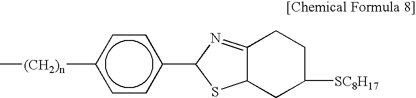

The surface of the anode 11 in contact with the hole-transport layer 12 may be subjected to vertical alignment treatment to provide the side-chain liquid crystalline polymer on a vertical alignment surface. This vertical alignment surface allows the side chain parts 16 to be aligned toward the cathode 21.

The above organic EL device 300 of this embodiment emits light from the bottom surface of the substrate 10 (from the polarizing layer 31) in response to current generated when a predetermined voltage is applied between the anode 11 and the cathode 21. In addition, external light entering the organic EL device 300 through the polarizing layer 31 passes through the ¼ wavelength layer 30, reflects off the cathode 21, passes through the ¼ wavelength layer 30 again, and enters the polarizing layer 31. The ¼ wavelength layer 30 then produces a phase shift to convert the external light component into linearly polarized light having a deviation of 90° from the external light entering the device 300. This linearly polarized light is absorbed into the polarizing layer 31 and therefore does not leak out of the organic EL device 300.

According to this embodiment, as described above, the hole-transport layer 12 is an organic functional layer containing a side-chain liquid crystalline polymer. The main chain parts 17 of the side-chain liquid crystalline polymer are parallel to the anode 11, and the side chain parts 16 face the cathode 21. This hole-transport layer 12 can provide higher conductivity between the anode 11 and the cathode 21 to achieve higher hole-injection/transport properties. The organic EL device 300 can therefore emit brighter light when a predetermined voltage is applied between the anode 11 and the cathode 21.

This organic EL device 300, having better luminous characteristics, can provide about five times as high luminous efficiency as organic EL devices in which a main-chain liquid crystalline polymer is randomly aligned in a plane.

According to this embodiment, additionally, the organic EL device 300 can effectively prevent deterioration in contrast due to the reflection of external light. Furthermore, the organic EL device 300, including an organic functional layer containing a side-chain liquid crystalline polymer, can operate at high efficiency to achieve a high-quality display.

The technical scope of the present invention is not limited to the above embodiments; various modifications are permitted within the spirit of the present invention.

[Electronic Appliance]

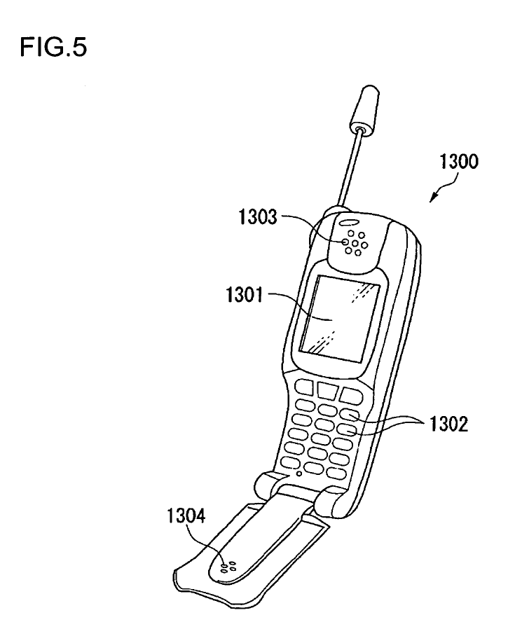

FIG. 5 is a perspective view of an example of an electronic appliance having an organic EL device according to the above embodiments. In FIG. 5, a cellular phone 1300 includes operation buttons 1302, an earpiece 1303, a mouthpiece 1304, and a display 1301 including the organic EL device according to the above embodiments. This cellular phone 1300 can provide a high-quality display with brightness and high contrast thanks to the organic EL device.

Other examples of electronic appliances having an organic EL device according to the present invention include digital cameras, personal computers, televisions, portable televisions, camcorders with a viewfinder or monitor, PDAs, portable video games, car audio systems, car instruments, CRTs, car navigation systems, pagers, electronic organizers, calculators, clocks, word processors, work stations, videophones, POS terminals, and devices with touch panels.

1. An organic electroluminescent device comprising:
a substrate; and
an organic electroluminescent element provided on the substrate, comprising a first electrode, a second electrode, and an organic functional layer disposed therebetween, the organic functional layer comprising a side-chain liquid crystalline polymer comprising side chain parts facing the first or second electrode.

2. The organic electroluminescent device according to claim 1, wherein the side chain parts are substantially perpendicular to the first or second electrode.

3. The organic electroluminescent device according to claim 1, wherein the layer in contact with the organic functional layer is subjected to vertical alignment treatment.

4. The organic electroluminescent device according to claim 1, wherein the organic functional layer is a luminescent layer, a hole-transport layer, or an electron-transport layer.

5. The organic electroluminescent device according to claim 1, further comprising:
a polarizing layer disposed on the light-emitting side of the substrate; and
a ¼ wavelength layer disposed between the polarizing layer and the substrate.

6. An electronic appliance comprising the organic electroluminescent device according to claim 1.
